(19) United States
(12) Patent Application Publication
(10) Pub. No.: US 2025/0365242 A1
(43) Pub. Date: Nov. 27, 2025

(54) METHOD, MEDIUM AND APPARATUS FOR SUB-FLOW DIFFERENTIATION

(71) Applicant: Huawei Technologies Co., Ltd., Shenzhen (CN)

(72) Inventors: Hao Tang, Ottawa (CA); Liqing Zhang, Ottawa (CA); Jianglei Ma, Ottawa (CA); Lei Dong, Shanghai (CN)

(21) Appl. No.: 19/294,757

(22) Filed: Aug. 8, 2025

Related U.S. Application Data
(63) Continuation of application No. PCT/CN2023/075085, filed on Feb. 9, 2023.

(51) Int. Cl. H04L 47/2441; H04L 1/20

(52) U.S. Cl. CPC H04L 47/2441; H04L 1/203

(57) ABSTRACT

A method includes receiving a packet including: a first part, where the first part of the packet is represented by bits of a first class, and a second part, where the second part of the packet is represented by bits of a second class. The method further includes transmitting the bits of the first class with a first air interface configuration, and transmitting the bits of the second class with a second air interface configuration.

### CROSS-REFERENCE TO RELATED APPLICATION

This application is a continuation of International Application No. PCT/CN2023/075085, filed on Feb. 9, 2023, the contents of which are hereby incorporated by reference in its entirety.

### TECHNICAL FIELD

The present disclosure relates, generally, to data communication and, in particular embodiments, to differentiating an important data sub-flow from another data sub-flow within a flow of data and transmitting the important data sub-flow with more reliability than the other data sub-flow.

### BACKGROUND

In wireless communication networks, it is typical that a user equipment (UE) is served by a base station (BS). Currently, artificial intelligence (AI) strategies and, in particular, machine learning (ML) strategies are being investigated to enhance communication between the UE and the BS. One specific type of machine learning is associated with a “wireless federated learning (FL)” model.

The wireless FL technique may be understood to be a machine learning technique that may be used to train what may be generically called an AI/ML model across a plurality of decentralized edge nodes (e.g., UEs, next Generation NodeBs, “gNBs”). According to the wireless FL technique, a BS may provide, to a UE, a set of model parameters (e.g., weights, biases, gradients) that describe a global AI/ML model. The UE may initialize a local AI/ML model using the received global AI/ML model parameters. The UE may then train the local AI/ML model using local data samples to, thereby, produce a trained local AI/ML model. The UE may then provide, to the BS, a set of AI/ML model parameters that describe the local AI/ML model.

This single forth (BS to UE) and back (UE to BS) of AI/ML model parameters may be understood to be just one exchange of AI/ML model parameters among multiple exchanges of AI/ML model parameters. The multiple exchanges of AI/ML model parameters may be associated with carrying out the iterative wireless FL technique. Notably, the wireless FL technique does not involve exchange of local data samples. Indeed, the local data samples remain at respective UEs.

Upon receiving, from a plurality of UEs, a plurality of sets of AI/ML model parameters that describe respective local AI/ML models at the plurality of UEs, the BS may aggregate the local AI/ML model parameters reported from the plurality of UEs and, based on such aggregation, update the global AI/ML model. A subsequent iteration progresses much like the first iteration. The BS and the UEs may then perform multiple iterations until the global AI/ML model is considered to be finalized.

### SUMMARY

By differentiating an important data sub-flow from a less than important data sub-flow within a flow of data, the important data sub-flow may be transmitted with more reliability than the sub-flow of data identified as less than important. Such a differentiation may be of particular use when the data is part of an exchange of data related to training and use of an AI/ML model. By establishing a higher priority, higher reliability or a higher degree of protection for data determined to be more important, processing that is reliant upon the important data may be shown to be accomplished with increased efficiency.

It may be considered that quantity of the data exchanged when the BS and the UE exchange AI/ML model parameters is unreasonably high. Furthermore, it may be shown that a significant portion of the data exchanged when the BS and the UE exchange AI/ML model parameters is redundant.

Aspects of the present application relate to identifying important data within a data flow, especially when the data within the data flow is representative of AI/ML model parameters. Aspects of the present application relate to defining a format for local traffic. Aspects of the present application relate to design schemes for priority transmission of data identified as being important data. That is, important data may receive a first priority and less important data may receive a second priority. The second priority may be, for example, a best effort level of priority.

Aspects of the present application relate to a design of a local traffic format for air interface transmission. The design implements sub-flow unequal protection transmission. Conveniently, it may be shown that, through the use of such a design, air interface overhead is significantly reduced while AI/ML model performance is not significantly degraded.

Conveniently, aspects of the present application relate to supporting dynamic indications of the classification of Class A data and Class B data. It may be shown that performance of training an AI model may be improved by dynamically making changes to the importance of given data.

Aspects of the present application may be shown to reduce air interface overhead through use of a differentiated transmission scheme based on an identification of a quality of data carried by a hyper-frame.

According to an aspect of the present disclosure, there is provided a method. The method includes receiving a packet including a first part, where the first part of the packet is represented by bits of a first class, and a second part, where the second part of the packet is represented by bits of a second class. The method further includes transmitting the bits of the first class with a first air interface configuration and transmitting the bits of the second class with a second air interface configuration.

According to an aspect of the present disclosure, there is provided an apparatus. The apparatus includes a memory storing instructions and a processor. The processor may be caused, by executing the instructions, to receive a packet including a first part, where the first part of the packet is represented by bits of a first class, and a second part, where the second part of the packet is represented by bits of a second class, transmit the bits of the first class with a first air interface configuration and transmit the bits of the second class with a second air interface configuration.

According to an aspect of the present disclosure, there is provided a method. The method includes transmitting a hyper-frame to a user equipment (UE), wherein the hyper-frame includes bits of a first class and bits of a second class.

According to an aspect of the present disclosure, there is provided an apparatus. The apparatus includes a memory storing instructions and a processor. The processor may be caused, by executing the instructions, to transmit a hyper-frame to a user equipment (UE), wherein the hyper-frame includes bits of a first class and bits of a second class.

According to an aspect of the present disclosure, there is provided a method. The method includes indicating, to a user equipment (UE), a quality of a hyper-frame, wherein the quality of the hyper-frame relates to an importance of content of the hyper-frame as the content applies to performance of a system, and transmitting, to the UE, the hyper-frame.

According to an aspect of the present disclosure, there is provided an apparatus. The apparatus includes a memory storing instructions and a processor. The processor may be caused, by executing the instructions, to indicate, to a user equipment (UE), a quality of a hyper-frame, wherein the quality of the hyper-frame relates to an importance of content of the hyper-frame as the content applies to performance of a system and transmit, to the UE, the hyper-frame.

According to an aspect of the present disclosure, there is provided a method. The method includes indicating, to a user equipment (UE), a quality of a hyper-frame and transmitting, to the UE, the hyper-frame.

According to an aspect of the present disclosure, there is provided a method. The method includes receiving, from a base station, configuration information, generating, according to the configuration information, a hyper-frame, the hyper-frame having a quality, indicating, to the base station, the quality of the hyper-frame and transmitting, to the base station, the hyper-frame.

According to an aspect of the present disclosure, there is provided a method. The method includes receiving, from a base station, configuration information, generating, according to the configuration information, a hyper-frame, the hyper-frame having a type, indicating, to the base station, the type of the hyper-frame and transmitting, to the base station, the hyper-frame.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates example steps in a method of transmitting data, in accordance with aspects of the present application;

FIG. 7 illustrates a table populated with examples of Class A data and Class B data, in accordance with aspects of the present application;

FIG. 8 illustrates a structure for a hyper-frame format, in accordance with aspects of the present application;

FIG. 9 illustrates a chart that includes example aspects of transmission protection in the network cross-referenced against class of data, in accordance with aspects of the present application;

FIG. 10 illustrates an example of a joint indication table, in accordance with aspects of the present application;

FIG. 11A illustrates a local traffic hyper-frame generated in a manner consistent with the local traffic hyper-frame format illustrated in FIG. 8, in accordance with aspects of the present application;

FIG. 11B illustrates the local traffic hyper-frame of FIG. 11 divided into three segments, in accordance with aspects of the present application;

FIG. 11C illustrates the local traffic hyper-frame of FIG. 11 divided into two segments, in accordance with aspects of the present application;

FIG. 12 illustrates example steps in a method of transmitting data, in accordance with aspects of the present application;

FIG. 13 illustrates a hyper-frame type table, in accordance with aspects of the present application;

FIG. 14 illustrates example steps in a method of transmitting data, in accordance with aspects of the present application;

FIG. 15 illustrates an example unified table, in accordance with aspects of the present application;

FIG. 16A illustrates an example table for a situation wherein the local traffic type is AI/ML data, in accordance with aspects of the present application;

FIG. 16B illustrates an example table for a situation wherein the local traffic type is sensing data, in accordance with aspects of the present application; and

FIG. 17 illustrates an example air interface transmission configuration table, in accordance with aspects of the present application.

### DETAILED DESCRIPTION OF THE ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

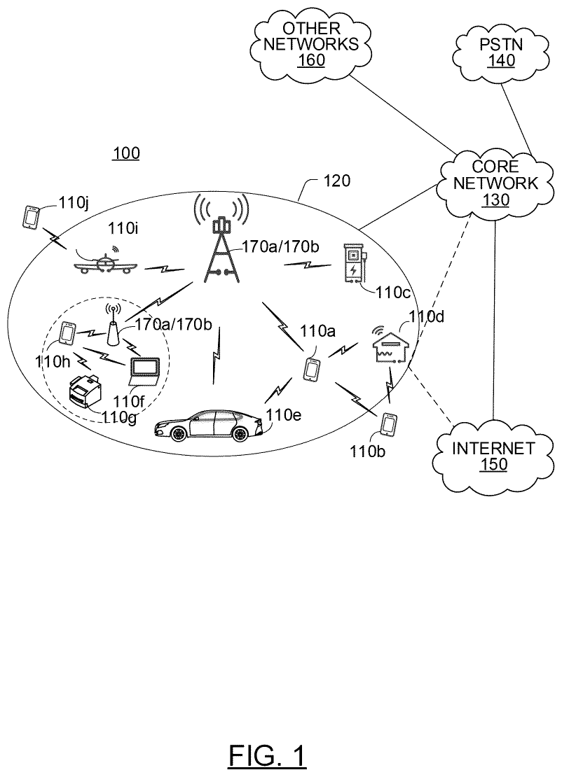

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

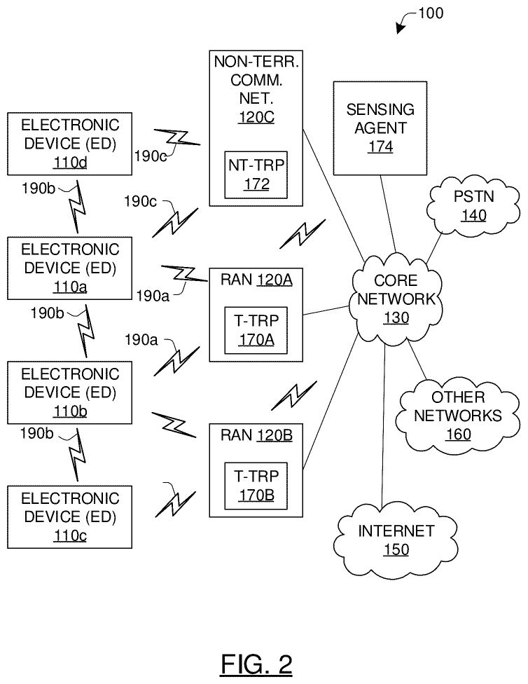

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Direct Fourier Transform spread OFDMA (DFT-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

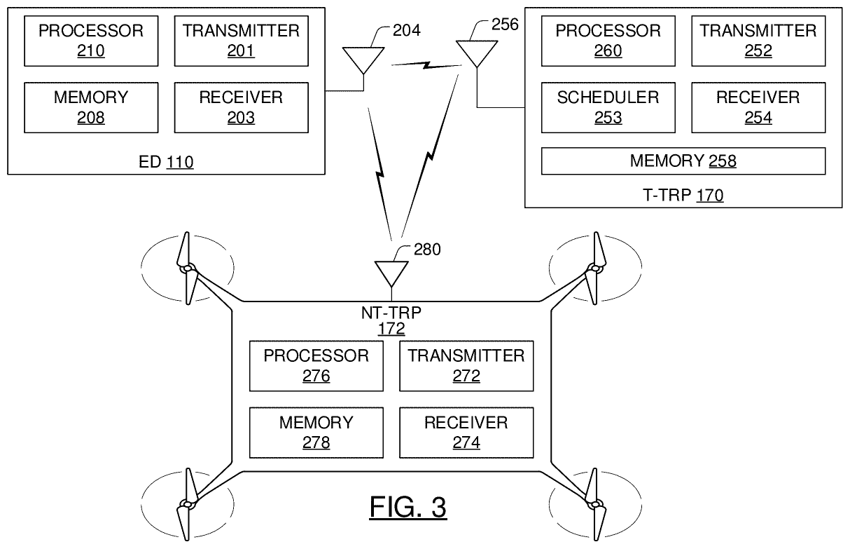

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearable devices such as a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a Central Processing Unit (CPU), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

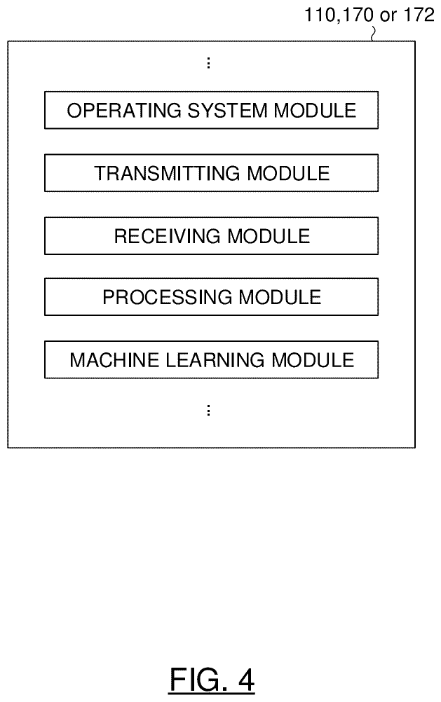

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a CPU, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Direct Fourier Transform spread OFDM (DFT-OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; OFDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling such as the known downlink control channel (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

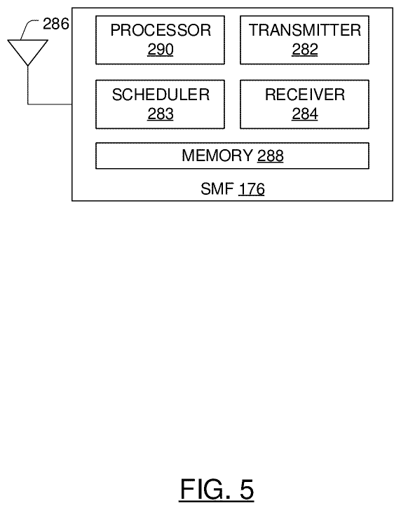

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectral efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectral efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or a SSB resource identifier, or a sounding reference signal (SRS) resource identifier, or other reference signal resource identifier.

In a single iteration of the wireless FL technique, the provision, to the BS by the UE of a set of AI/ML model parameters that describe the local AI/ML model, may be considered to involve a transfer of a relatively large quantity of parameters. The size (relatively large) of the quantity of parameters may be understood to be due to a relatively large number of neural nodes and connections (between neural nodes) in the local AI/ML model.

It may be shown that a relatively small AI/ML model may be described using in the order of millions of parameters. It may be shown that a relatively large AI/ML model may be described using in the order of billions of parameters. An example AI/ML model may be found in the Bidirectional Encoder Representations from Transformers (BERT) proposed in a paper by researchers at Google AI Language. The BERT AI/ML model may be shown to be described using 0.34 billion parameters.

It may be shown that most of the parameters exchanged, say, as part of a wireless FL technique, are redundant. In Lin, Y., Han, S., Mao, H., Wang, Y., & Dally, W. J. “Deep Gradient Compression: Reducing the Communication Bandwidth for Distributed Training” (2017) arXiv (available at doi.org/10.48550/arXiv.1712.01887), it was found that 99.9% of the gradients exchanged may be considered to be redundant. In an image classification example, it was illustrated that the quantity of gradient data exchanged may be reduced from 97 MB to 0.35 MB.

That is, the quantity of data exchanged may be reduced by only exchanging data deemed to be important to improving the operation of a given AI/ML model.

Aspects of the present application relate to identifying important data (e.g., important parameters) within a packet. Furthermore, aspects of the present application relate to design schemes that involve using a priority transmission for the data identified as being important and “best effort” transmission for data that identified as being less than important. Indeed, in the following, reference is often made to a “local traffic packet.” However, it should be clear that aspects of the present application may be applied to scenarios involving packets that are other than local traffic packets. For but two other examples, the packet may be uplink control information or may be downlink control information.

Since aspects of the present application are expressed, in the following, in relation to local traffic, it appears that a definition of local traffic would be of use. Local traffic may be defined to include those messages, e.g., signaling messages or data messages, that are communicated such that the messages can be discerned and interpreted by the RAN 120. For example, the signaling messages or data messages may be communicated using a standard protocol or a standard air interface, either of which may be defined by 3GPP RAN (available at 3gpp.org). It follows that the signaling messages or the data messages are visible at the RAN 120 and the data format and the data transmission schemes are within the scope of 3GPP standardization. In future generations of wireless communication networks, including, for example, the sixth generation (6G) wireless communication networks, it is contemplated that there will be provisions for communications of messages within RANs 120. These messages may be generated at the BS 170 and transmitted to the UE 110.

Local traffic may be defined to include AI model traffic, AI data traffic, AI parameter traffic, sensing data traffic, positioning data traffic, etc.

According to aspects of the present application, a BS 170 or a UE 110 may divide a local traffic flow into multiple traffic sub-flows (multiple classes) according to a determined subjective importance of data within the local traffic flow. In those cases wherein the local traffic flow is part of a DL transmission, it is the BS 170 that carries out the step of dividing a local traffic flow into multiple traffic sub-flows. In those cases wherein the local traffic flow is part of a UL transmission, it is the UE 110 that carries out the step of dividing a local traffic flow into multiple traffic sub-flows.

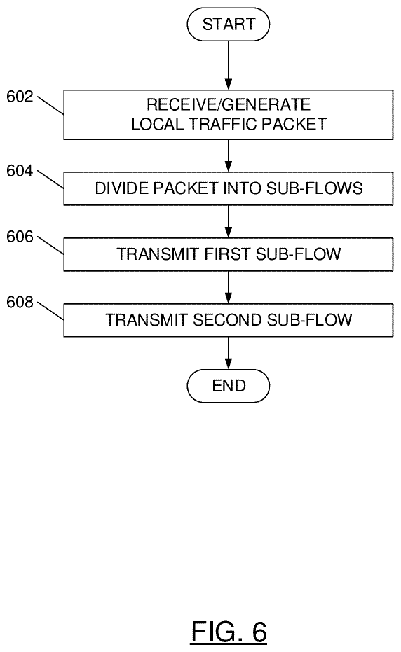

FIG. 6 illustrates example steps in a method of transmitting data. The method may be considered to be carried out by an entity, where the entity may be a BS 170 or a UE 110. Initially, the entity may receive (step 602) a local traffic packet as part of a flow of data. Equally, the entity may generate (step 602) a local traffic packet as part of a flow of data. The flow of data may, for example, be representative of parameters describing an artificial intelligence model. The local traffic packet may including first data and second data. Responsive to receiving (step 602) the local traffic packet, the entity may divide (step 604) the local traffic packet into a first sub-flow including the first data and a second sub-flow including the second data. The entity may then transmit (step 606) the first sub-flow with a first reliability and transmit (step 608) the second sub-flow with a second reliability, the second reliability being lower than the first reliability.

There may be data within the local traffic flow that is determined to be “Class A” data. Class A data may be defined to be the most important data. That is, Class A data may be defined to be the data that is most sensitive to errors. Indeed, in aspects of the present application, it is not really the data that is “sensitive.” It would be more accurate to say that the AI/ML model that is to make use of the data, upon receipt of the data, is highly sensitive to errors in the Class A data. It follows that the Class A data should be associated with the highest reliability among multiple classes of data.

There may be data within the local traffic flow that is determined to be “Class B” data. Class B data may be defined to be data associated with a normal importance. The AI/ML model that is to make use of the data, upon receipt of the data, is normally sensitive to errors in Class B data. It follows that Class B data should be associated with a normal reliability among multiple classes of data. In other aspects of the present application, a distinction may be made between Class A data and Class B data by determining that the Class A data is associated with a target block error rate (BLER) that is lower than the target BLER that is associated with the Class B data. In other aspects of the present application, a distinction may be made between Class A data and Class B data by determining that the Class A data is associated with a residual BLER that is lower than the residual BLER that is associated with the Class B data.

There may be data within the local traffic flow that is determined to be “Class C” data. Class C data may be defined to be data associated with lower importance. The AI/ML model that is to make use of the data, upon receipt of the data, is not very sensitive to errors in the Class C data. That is, some errors in reception of the Class C data will not greatly degrade (i.e., there may be a slight impact upon) a measure of the performance of training the AI/ML model. Furthermore, some errors in reception of the Class C data will not greatly degrade a measure of the performance of inference obtained from the AI/ML model. Even further, some errors in reception of the Class C data will not greatly degrade a measure of the performance of sensing results derivation obtained from the AI/ML model. It follows that the Class C data should be associated with a lower reliability among multiple classes of data.

The foregoing discussion contemplates three classes of data. It should be clear that aspects of the present application may operate on the basis of as few as two classes of data. Moreover, aspects of the present application may operate on the basis of four classes of data or many more than four classes of data.

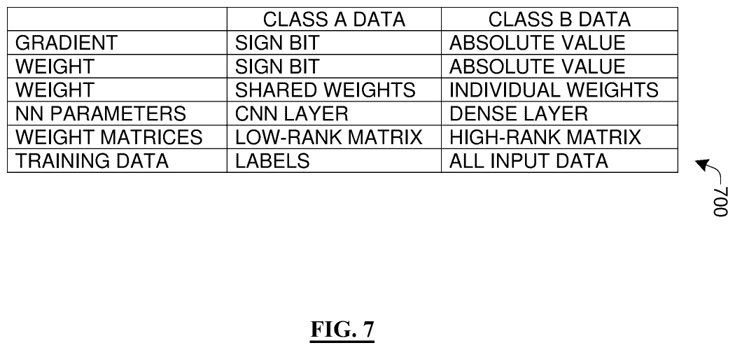

For an example scenario, consider that a given local traffic flow includes data that may be divided among two classes: Class A; and Class B. FIG. 7 illustrates a table 700 populated with examples of Class A data and Class B data. In table 700 of FIG. 7, the importance of Class A data is greater than the importance of Class B data.

When the given local traffic flow is information related to training an AI/ML model, the given local traffic flow may be a gradient update. It is expected that a gradient update may be represented using eight bits: seven bits to represent an absolute value of the gradient update; and a single bit to represent a sign for the gradient update. In table 700 of FIG. 7, it is proposed that the sign bit, for a gradient update, is Class A data and the collection of seven bits representative of the absolute value of the gradient update is Class B data. Notably, the gradient update need not necessarily be represented using eight bits.

It may be shown that the direction, i.e., the sign bit, of the gradient update is more important than the absolute value of the gradient update. That is, a change to the gradient, which may be either an increase or a decrease, is more important than the degree to which the gradient is to change. Consider a scenario wherein the absolute value of a gradient update is lost in transmission, that is, the learning node (the BS 170 or the UE 110 that receives the gradient update) determines (say, using a cyclic redundancy check) that the received bits do not match the transmitted bits. In this scenario, the learning node may use a pre-defined or pre-configured value, e.g., a small absolute value, for the gradient update for the current iteration of learning. Alternatively, in this scenario, the learning node may use the absolute value of the gradient update received for a previous iteration.

When the given local traffic flow is information related to training an AI/ML model, the given local traffic flow may be a weight. In table 700 of FIG. 7, it is proposed that, for a weight, the sign is Class A data and the collection of bits representative of the absolute value is Class B data. In table 700 of FIG. 7, it is proposed that, for a weight, the data may be determined to be Class A data when the weight is a shared weight for multiple layers. In contrast, the data may be determined to be Class B data when the weight is an individual weight for a single layer. It may be shown that loss of a shared weight impacts performance for multiple layers. Accordingly, a shared weight may be determined to be Class A data.

When the given local traffic flow is information related to training an AI/ML model, the given local traffic flow may be Neural Network (NN) parameters. It may be shown that the NN parameters may be parameters of a Convolutional Neural Network (CNN) layer or parameters of a dense layer. An example parameter of a CNN layer is a kernel. In an example image classification AI/ML model, the kernel is a filter that is used to extract the features from images. In table 700 of FIG. 7, it is proposed that, for parameters of a CNN layer, the data may be determined to be Class A data and, for parameters of a dense layer, the data may be determined to be Class B data. Indeed, it may be shown that the CNN layer is important for extracting features from input data. Furthermore, the parameters of CNN layer may be shown to be much less plentiful than parameters of a dense layer.

When the given local traffic flow is information related to training an AI/ML model, the given local traffic flow may be a weight matrix. It may be shown that the weight matrix may be a low-rank weight matrix or a high-rank weight matrix. In table 700 of FIG. 7, it is proposed that, when the data is a low-rank weight matrix, the data may be determined to be Class A data and, when the data is a high-rank weight matrix, the data may be determined to be Class B data. It may be shown that a low-rank matrix contains fewer non-zero parameters than a high-rank matrix. A low number of non-zero parameters may be shown to be important for an AI/ML model. In contrast, a high-rank matrix may be shown to contain many more parameters than a low-rank matrix. Accordingly, some error in the reception of a high-rank matrix may be considered acceptable.

When the given local traffic flow is training data for training an AI/ML model, the given local traffic flow may be data labels for supervised learning or input data. In table 700 of FIG. 7, it is proposed that, when the data is data labels for supervised learning, the data may be determined to be Class A data and, when the data is input data, the data may be determined to be Class B data.

A scenario where the data may be divided into three classes may be briefly considered. For a gradient update with an N-bit absolute value, it is proposed herein that the sign bit is Class A data, the K most significant bits (MSB) in the absolute value is Class B data and the N−K least significant bits (LSB) in the absolute value is Class C data. It should be clear that the MSB represent larger value than the LSB, so the value expressed by the K MSB bits is closer to the real absolute value than the value expressed by the N−K LSB bits.

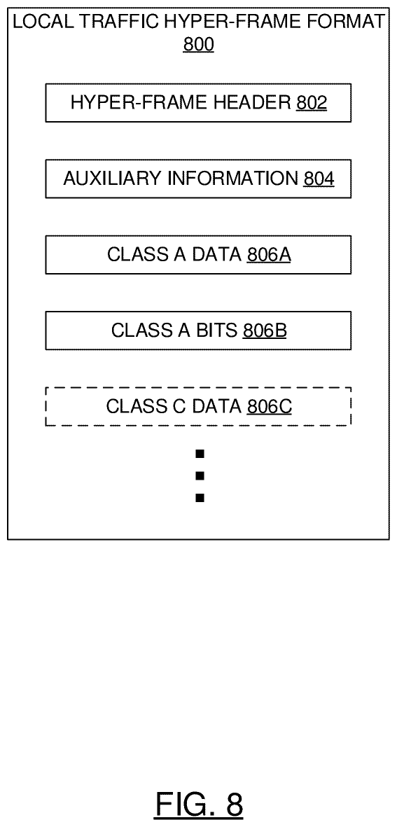

A local traffic packet may be expected to be encoded into a local traffic hyper-frame, which may also be referenced as a hyper-packet. The data in the local traffic packet may, for several examples, be data representative of an AI/ML model, AI data or sensing data. A format for the hyper-frame may follow a structure illustrated in FIG. 8. The local traffic hyper-frame format 800 is illustrated as including parts such as a hyper-frame header 802, auxiliary information 804, Class A data 806A, Class B data 806B and, optionally, data of less important classes, starting with Class C data 806C. Notably, the auxiliary information 804 may be considered to be optional in that the information in the auxiliary information 804 may, instead, be included in the hyper-frame header 802.

The hyper-frame header 802 may include one or more of a hyper-frame ID, a local traffic type and a hyper-frame quality indicator. For two non-limiting examples, the local traffic type may be AI/ML data or sensing data. The quality indicator, which will be described in detail hereinafter, may be understood to refer to an importance of the content of the hyper-frame as the content applies to a network/system performance, e.g., AI/ML performance (AI training, inference) or sensing performance (deriving sensing information). An indication of a relatively higher quality may be understood to correspond to content that is relatively more important to the performance.

The auxiliary information 804 may include one or more of a NN model indicator, a hyper-parameter of the NN model, a task of the local traffic and classifications for the Class A data 806A and the Class B data 806B and, optionally, other classes of data. The hyper-parameter of the NN model may be, for but two examples, an activation function or a learning rate. The task of the local traffic may, for example, indicate that the local traffic is related to anomaly sensing or environment sensing.

The local traffic hyper-frame 800 may be divided into multiple segments. Each segment, among the multiple segments, may be shown to include a hyper-frame ID. Generally, the transmission of the Class A 806A data has a higher priority than the transmission of the Class B data 806B.

Optionally, a plurality of transport blocks (TBs) may be constructed for the Class A data and a separate plurality of TBs may be constructed for the Class B data. A first transmission mode may be used for transmission of the TBs carrying the Class A data 806A. A second transmission mode may be used for transmission of the TBs carrying the Class B data 806B. The first transmission mode may be selected to have a higher reliability than the second transmission mode. If the Class A data 806A in the local traffic hyper-frame 800 is not successfully received, the transmission of the Class B data 806B may be suspended.

To enable more protection for the Class A data 806A, the different classes of data may be subject to different transmission protection in the network.

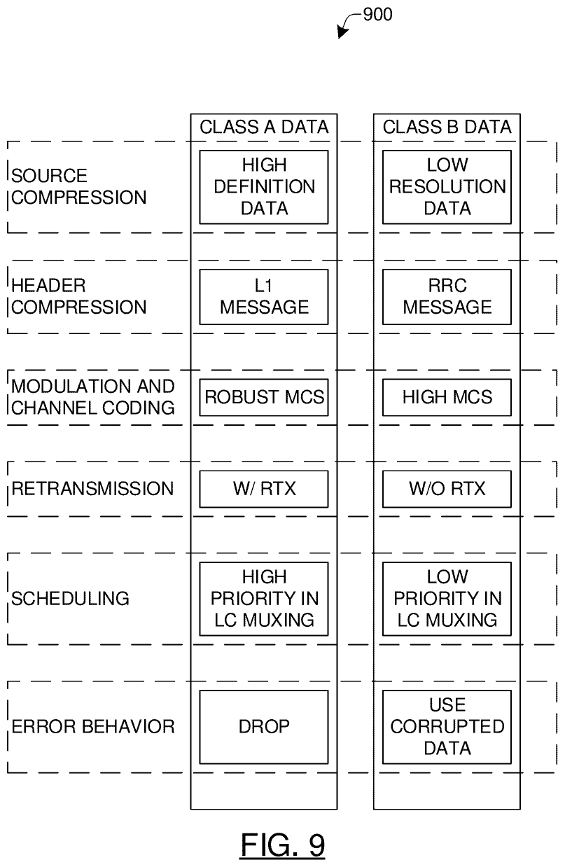

FIG. 9 illustrates a chart 900 that includes example aspects of transmission protection in the network cross-referenced against class of data.

A first aspect of transmission protection is source compression. According to the chart 900 illustrated in FIG. 9, Class A data may be subject to a relatively low compression ratio, such that the Class A data is transmitted as high definition data. The compression ratio may be defined as

$$compression ratio = ( 1 - \frac{number of bits after compression}{number of bits before compression} ) .$$

According to the chart 900 illustrated in FIG. 9, Class B data may be subject to a relatively high compression ratio, such that the Class B data is transmitted as low resolution data. That is, the compression ratio and/or the compression algorithm used for Class A data may be distinct from the compression ratio and/or the compression algorithm for Class B data. The source compression configuration (the compression ratio and/or the compression algorithm) may be indicated, to the UE 110, by the BS 170. The source compression configuration (the compression ratio and/or the compression algorithm) may be indicated in the hyper-frame header 802 or the auxiliary information 804 (see FIG. 8).

A second aspect of transmission protection is header compression. According to the chart 900 illustrated in FIG. 9, the Class A data may be subject to less header overhead relative to the Class B data. For one example, the Class A data may be carried by Layer 1 (L1) messages. For another example, the Class A data may be carried by RRC signaling with Robust Header Compression (ROHC). In contrast, the Class B data may be carried by RRC signaling messages.

A third aspect of transmission protection is a Modulation Coding Scheme (MCS). According to the chart 900 illustrated in FIG. 9, the Class A data may be subject to so-called robust MCS. Examples of robust MCS include use of a so-called robust Channel Quality Indicator (CQI) table with a 1% target block error rate (BLER) and/or use of relatively lower modulation orders (e.g., up to 64 quadrature amplitude modulation—also called 64 QAM). According to the chart 900 illustrated in FIG. 9, the Class B data may be subject to so-called best effort MCS. Examples of best effort MCS include use of a CQI table with 10% target BLER and/or use of relatively higher modulation orders (e.g., up to 1024 QAM).

A fourth aspect of transmission protection is retransmission. According to the chart 900 illustrated in FIG. 9, the Class A data may be subject to retransmission enabled with Automatic Repeat Request (“ARQ”) and or hybrid ARQ (“HARQ”). According to the chart 900 illustrated in FIG. 9, the Class B data may not benefit from retransmission. Alternatively, the Class B data may be subject to retransmission without HARQ and/or ARQ. Further alternatively, the Class B data may be subject to retransmission that are capped at a maximum retransmission number. The maximum retransmission number may be smaller for the Class B data than the maximum retransmission number for the Class A data. Indeed, the maximum retransmission number may be separately configured or pre-defined for the Class A data and the Class B data.

A fifth aspect of transmission protection is scheduling. According to the chart 900 illustrated in FIG. 9, the Class A data may be subject to relatively higher priority in Logical Channel (LC) multiplexing (“muxing”). According to the chart 900 illustrated in FIG. 9, the Class B data may be subject to relatively lower priority in LC multiplexing.

A sixth aspect of transmission protection is error behavior. According to the chart 900 illustrated in FIG. 9, when there is a failure, at a receiver, to decode the bits of the Class A data, the receiver may drop the Class A data. In contrast, when there is a failure, at a receiver, to decode the bits of the Class B data, the receiver may use the Class B data, even though the Class B data is known to be corrupted data.

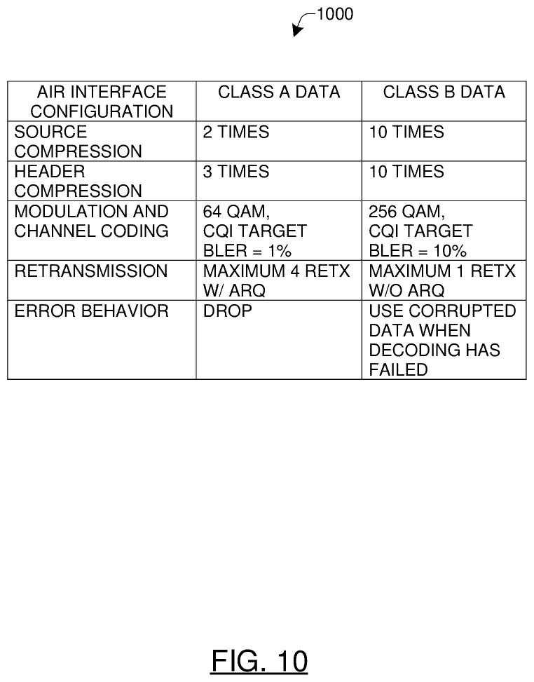

Aspects of the present application relate to separately configuring, for Class A data and for Class B data, one or more of the following parameters: source compression; header compression; modulation and channel coding; retransmission; scheduling; and error behavior. The separate configuration may be jointly indicated for the Class A data and the Class B data, or may be indicated using separate signaling to configure parameters for the Class A data and for the Class B data. FIG. 10 illustrates an example of a joint indication table 1000, wherein each row of the table 1000 includes indications of a specific configuration of one of the parameters for the Class A data and the Class B data.

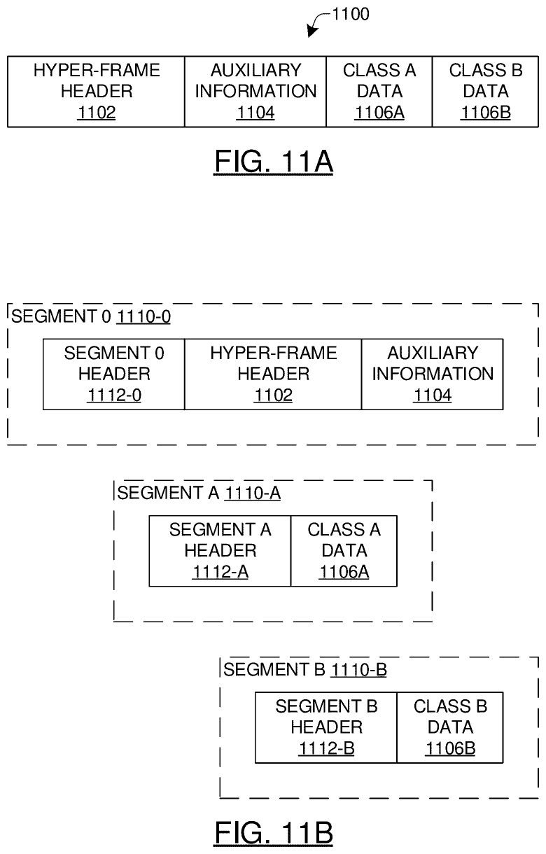

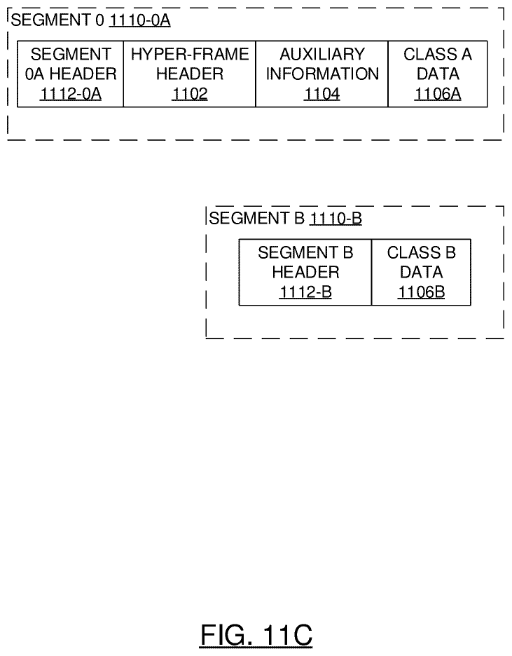

FIG. 11A illustrates a local traffic hyper-frame 1100 generated in a manner consistent with the local traffic hyper-frame format 800 illustrated in FIG. 8. The local traffic hyper-frame 1100 includes a hyper-frame header 1102, auxiliary information 1104, Class A data 1106A and Class B data 1106B.

The transmitting entity may divide the local traffic hyper-frame 1100 into three segments. The three segments are illustrated in FIG. 11B. A first segment, among the three segments, may be referenced as “segment-0” 1110-0. Segment-0 1110-0 includes a segment-0 header 1112-0, the hyper-frame header 1102 and the auxiliary information 1104. A second segment, among the three segments, may be referenced as “segment-A” 1110-A. The segment-0 header 1112-0 may include an indication of a local traffic Sequence Number (SN). Segment-A 1110-A includes a segment-A header 1112-A and the Class A data 1106A. The segment-A header 1112-A may include an indication of the local traffic SN. A third segment, among the three segments, may be referenced as “segment-B” 1110-B. Segment-B 1110-B includes a segment-B header 1112-B and the Class B data 1106B. The segment-B header 1112-B may include an indication of the local traffic SN.

The indication, in the segment-0 header 1112-0, the segment-A header 1112-A and the segment-B header 1112-B, of the same local traffic SN may be shown to allow a receiving device to determine that segment-0 1110-0, segment-A 1110-A and segment B 1110-B are from the same local traffic hyper-frame, namely, the local traffic hyper-frame 1100 of FIG. 11A.

As an alternative to dividing the local traffic hyper-frame 1100 into three segments, the local traffic hyper-frame 1100 may be divided into two segments. The two segments are illustrated in FIG. 11C. A first segment, among the two segments, may be referenced as “segment-0A” 1110-0A. Segment-0A 1110-0A includes a segment-0A header 1112-0A, the hyper-frame header 1102, the auxiliary information 1104 and the Class A data 1106A. The segment-0A header 1112-0A may include an indication of a local traffic SN. A second segment, among the two segments, may be referenced as “segment-B” 1110-B. Segment-B 1110-B includes the segment-B header 1112-B and the Class B data 1106B. The segment-B header 1112-B may include an indication of the local traffic SN.

The indication, in the segment-0A header 1112-0A and the segment-B header 1112-B, of the same local traffic SN may be shown to allow a receiving device to determine that segment-0A 1110-0A and segment B 1110-B are from the same local traffic hyper-frame, namely, the local traffic hyper-frame 1100 of FIG. 11A.

It is notable that further segmentation may occur as the local traffic hyper-frame 1100 is processed through the 5G/NR Radio Protocol Stack Architecture (or future Protocol Stack Architectures, such as a 6G Protocol Stack Architecture). The 5G/NR Radio Protocol Stack Architecture includes a service data adaptation protocol (SDAP) layer, a packet data convergence protocol (PDCP) layer, a radio link control (RLC) layer, a medium access control (MAC) layer and the physical (PHY) layer. A degree to which the further segmentation may occur is dependent upon the specific layers through which the local traffic hyper-frame 1100 is processed. For example, if the local traffic hyper-frame 1100 is processed is generated in the SDAP layer, then the local traffic is sent from the SDAP layer to the PDCP layer, then to the RLC layer, then to the MAC layer, then to the PHY layer. In a layer during the processing, further segmentation may be performed. For one example, RLC segments may be generated at the RLC layer.

Subsequent to processing by the 5G/NR Radio Protocol Stack, the local traffic hyper-frame 1100 may be understood to be carried on multiple TBs. For MAC multiplexing on a TB with Class A data and Class B data, the Class A data may be shown to have a higher priority.

Aspects of the present application relate to configuring Intra-Hyper-Frame unequal protection transmission with support for dynamic indication of classification of the Class A data and the Class B data.

In accordance with aspects of the present application, a BS 170 may indicate, to a UE 110, the classification of Class A sub-flows and Class B sub-flows, e.g., by RRC, MAC-CE or DCI signaling.

In accordance with another aspect of the present application, a BS 170 may use the hyper-frame header or the auxiliary information in a hyper-frame to indicate the classification of Class A sub-flows and Class B sub-flows. In addition, it is also contemplated that the hyper-frame header or the auxiliary information may be used to indicate the nature of the hyper-frame contents.

In one example, the classification of Class A sub-flows and Class B sub-flows may be called a “task-oriented” classification. That is, the classification of the Class A sub-flows and the Class B sub-flows may be associated with a specific task.

By indicating the task to the UE 110, the BS 170 may allow the UE 110 to pre-determine the classification of the Class A sub-flows and the Class B sub-flows.

For one example, the BS 170 may indicate, to the UE 110, that a given hyper-frame is associated with an anomaly sensing task. Responsively, the UE 110 may expect that all of the data in the given hyper-frame is Class A data.

For another example, the BS 170 may indicate, to the UE 110, that a given hyper-frame is associated with an environment sensing task. Responsively, the UE 110 may expect that most of the data in the given hyper-frame is Class B data.

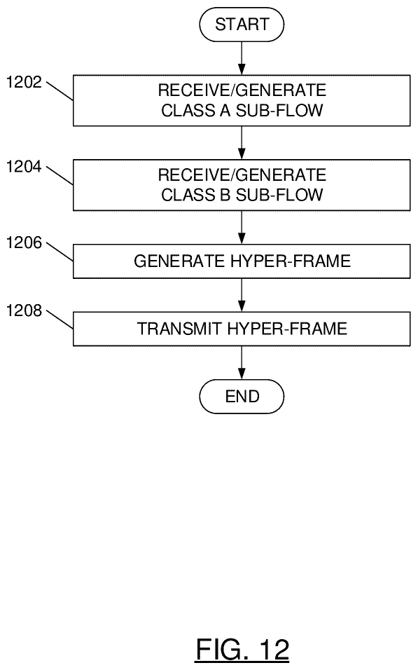

FIG. 12 illustrates example steps in a method of transmitting data. The method may be considered to be carried out by an entity, where the entity may be a BS 170 or a UE 110. Initially, the entity may receive/generate (step 1202) a Class A data sub-flow. The entity may further receive/generate (step 1204) a Class B data sub-flow. In a case wherein steps 1202 and 1204 are receiving steps, the entity may receive a local traffic packet and the local traffic packet may include, in a first part, the Class A data sub-flow and, in a second part, the Class B data sub-flow. The entity may then generate (step 1206) a hyper-frame, the hyper-frame including the Class A data sub-flow and the Class B data sub-flow. The entity may then transmit (step 1208) the hyper-frame. If the entity is a BS 170, the BS may transmit (step 1208) the hyper-frame to a UE 110.

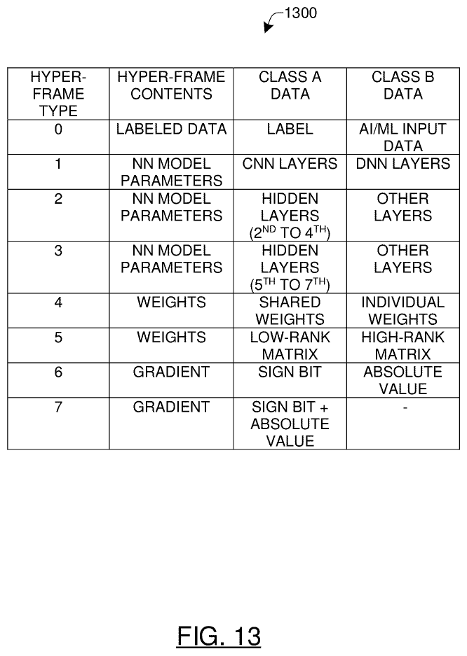

FIG. 13 illustrates a hyper-frame type table 1300. The hyper-frame type table 1300 of FIG. 13 provides an example of a configuration option wherein, through the indication of a hyper-frame type, a BS 170 may provide, to a UE 110, a joint indication of hyper-frame contents and classification of Class A sub-flows and Class B sub-flows.

According to hyper-frame type table 1300 of FIG. 13, when the BS 170 indicates that a given hyper-frame is a type 2 hyper-frame, the UE 110 may expect the content of the given hyper-frame to be NN parameters. Furthermore, the UE 110 may expect the given hyper-frame to include hidden layers (2^{nd} to 4^{th}) as Class A data and other layers as Class B data. According to hyper-frame type table 1300 of FIG. 13, when the BS 170 indicates that a given hyper-frame is a type 3 hyper-frame, the UE 110 may expect the content of the given hyper-frame to be NN parameters. Furthermore, the UE 110 may expect the given hyper-frame to include hidden layers (5^{th} to 7^{th}) as Class A data and other layers as Class B data. The distinction between type 2 hyper-frames and type 3 hyper-frames follows from an observation that, for a particular learning stage, the hidden layers from the 2^{nd} layer to the 4^{th} layer are nearly converged. Accordingly, it may be understood to be prudent to assign hidden layers (2^{nd} to 4^{th}) as Class A data, for transmission with a high priority, to enable correct transmission. For a distinct learning stage, the hidden layers from the 5^{th} layer to the 7^{th} layer are nearly converged. Accordingly, it may be understood to be prudent to assign hidden layers (5^{th} to 7^{th}) as Class A data, for transmission with a high priority, to enable correct transmission.

According to hyper-frame type table 1300 of FIG. 13, when the BS 170 indicates that a given hyper-frame is a type 6 hyper-frame, the UE 110 may expect the content of the given hyper-frame to be related to a gradient update. Furthermore, the UE 110 may expect the given hyper-frame to include the sign of the gradient update as Class A data and the absolute value of the gradient update as Class B data. According to the hyper-frame type table 1300 of FIG. 13, when the BS 170 indicates that a given hyper-frame is a type 7 hyper-frame, the UE 110 may expect the content of the given hyper-frame to be a gradient update. Furthermore, the UE 110 may expect the given hyper-frame to include both the sign of the gradient update and the absolute value of the gradient update as Class A data. The distinction between type 6 hyper-frames and type 7 hyper-frames follows from an observation that, during early stages of training, a particular model may not be sensitive to the size of the gradient update. Accordingly, only the sign of the gradient update may be treated as important data, e.g., Class A data. During later stages of training, the particular model may be understood to be nearly converged. Accordingly, the particular model may be understood to be sensitive to the absolute value of the gradient update. Accordingly, both the sign of the gradient update and the absolute value of the gradient update may be treated as important data, e.g., Class A data.

As mentioned hereinbefore, and standing in contrast to the joint indication of hyper-frame content and sub-flow classification represented by the hyper-frame type table 1300 of FIG. 13, a BS 170 may separately indicate, to a UE 110, a nature of the content of a given hyper-frame and a classification for Class A sub-flows and Class B sub-flows. The separate indication may be accomplished using, e.g., RRC signaling, MAC-CE signaling or DCI signaling. Further alternatively, the separate indication may be accomplished using the hyper-frame header or the auxiliary information in the hyper-frame.

Aspects of the present application relate to configuring Inter-Hyper-Frame unequal protection transmission with support for different priority for different types of local traffic.

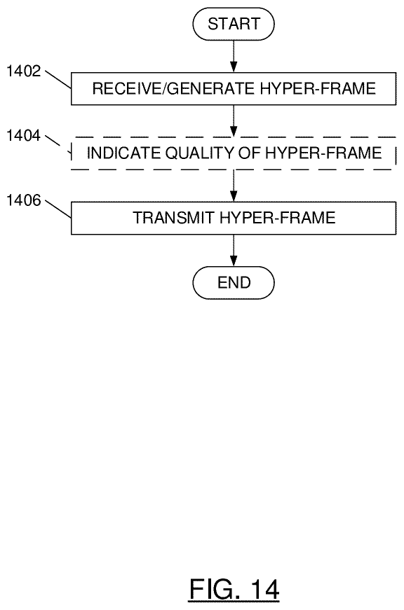

FIG. 14 illustrates example steps in a method of transmitting data. The method may be considered to be carried out by an entity, where the entity may be a BS 170 or a UE 110. Initially, the entity may receive/generate (step 1402) a hyper-frame, the hyper-frame including an indication of a quality of the hyper-frame. The quality of a hyper-frame may be understood to refer to an importance of the content of the hyper-frame as the content applies to a network/system performance, e.g., AI/ML performance (AI training, inference) or sensing performance (deriving sensing information). An indication of a relatively higher quality may be understood to correspond to content that is relatively more important to the performance.

The entity may then transmit (step 1406), to a receiving device, the hyper-frame. Furthermore, the entity may indicate, to the receiving device, the quality of the hyper-frame. In one aspect of the present application, the entity may indicate (step 1404) the quality of the hyper-frame before transmitting (step 1406) the hyper-frame. In another aspect of the present application, the entity may indicate the quality of the hyper-frame as part of transmitting (step 1406) the hyper-frame.

For downlink (DL) transmission, a BS 170 may indicate, to a UE 110, a hyper-frame type and/or a quality of a hyper-frame. In one aspect of the present application, the UE 110 may extract an indication of the hyper-frame type and/or the quality of the hyper-frame from the hyper-frame header or from the auxiliary information in a hyper-frame.

For uplink (UL) transmission, the BS 170 may configure the UE 110 to report data of an indicated hyper-frame type. Responsively, the UE 110 may be shown to report the corresponding data, optionally with an indication of the quality of the hyper-frame.

In another aspect of the present application, the UE 110 may self-determine a quality for a given hyper-frame. In conjunction with UL transmission of the given hyper-frame, the UE 110 may report, to the BS 170, an indication of the quality of the given hyper-frame. For example, the UE 110 may report the indication of the quality of the given hyper-frame in an UL channel. For another example, the UE 110 may report the indication of the quality of the given hyper-frame in the header of the given hyper-frame or in the auxiliary information of the given hyper-frame. Optionally, the UE 110 may also report an indication of the quality of the hyper-frame.

In aspects of the present application, a hyper-frame quality indicator may be used to indicate the quality of the data.

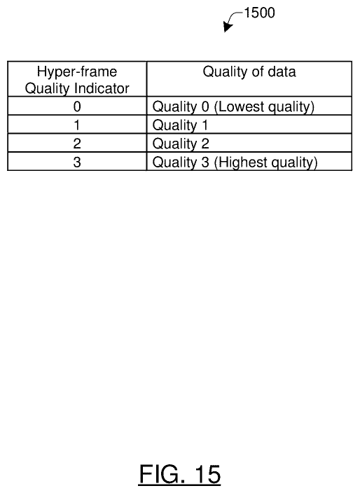

A first option, which may be considered useful for local traffic with multiple local traffic types, involves using a so-called “unified table” to define data of distinct quality. That is, upon receipt of a first hyper-frame with a first hyper-frame quality indicator, an entity may consult a unified table to associate a first quality of data with the first hyper-frame. Subsequently, upon receipt of a second hyper-frame with a second hyper-frame quality indicator, the entity may consult the unified table to associate a second quality of data with the second hyper-frame. The entity may then make a determination regarding which of the hyper-frames, among the first hyper-frame and the second hyper-frame, is carrying data of a higher quality. The entity may then treat the two hyper-frames differently in accordance with the determination. FIG. 15 illustrates an example unified table 1500.

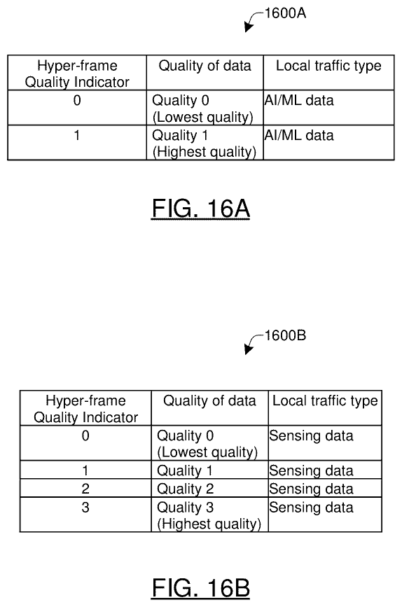

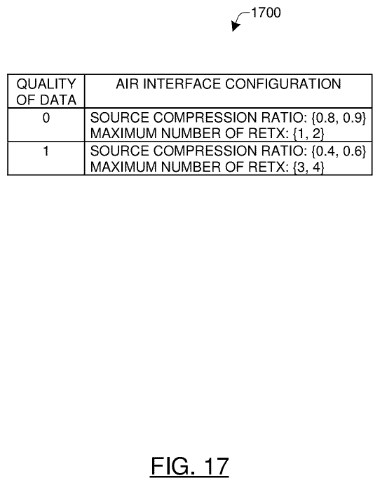

A second option involves separately indicating a quality of data within a type of local traffic. That is, an entity may first determine a type of local traffic represented by a particular hyper-frame. The entity may then determine a quality of data carried by the particular hyper-frame. The entity may then treat the particular hyper-frame differently from other hyper-frames of the same type of local traffic. FIG. 16A illustrates an example table 1600A for a situation wherein the local traffic type is AI/ML data. FIG. 16B illustrates an example table 1600B for a situation wherein the local traffic type is sensing data.

Rules for defining a quality of data for a particular sub-flow may be pre-established at the BS 170. Alternatively or additionally, the BS 170 may configure specific rules.

A first example rule may be defined to depend on a confidence of accuracy. That is, a hyper-frame carrying sensing data associated with a relatively higher confidence of accuracy may be associated with a higher hyper-frame quality indicator than a hyper-frame carrying sensing data associated with a relatively lower confidence of accuracy.

A second example rule may be defined to depend on an inference performance metric (e.g., an inference accuracy). That is, a hyper-frame carrying data for an AI/ML model with a relatively higher inference accuracy may be associated with a higher hyper-frame quality indicator than a hyper-frame carrying data for an AI/ML model with a relatively lower inference accuracy.

A third example rule may be defined to depend on the sensing task to which sensing data is related. That is, a hyper-frame carrying sensing data for anomaly detection may be associated with a higher hyper-frame quality indicator than a hyper-frame carrying sensing data for environment sensing. This definition follows from the anomaly detection task having latency and reliability requirements that are more stringent than the latency and reliability requirements associated with environment sensing.

A fourth example rule may be defined to depend on a reported delay of sensing data. That is, a hyper-frame carrying sensing data whose reported delay is relatively close to a delay threshold may be associated with a higher hyper-frame quality indicator than a hyper-frame carrying sensing data whose reported delay is relatively further away from the delay threshold.

A fifth example rule may be defined to depend on an importance of data for sensing data fusion. It is known that a BS 170 may collect sensing data from multiple UEs 110 and perform sensing data fusion to obtain so-called “big picture” sensing results. Accordingly, a hyper-frame carrying data that is determined to be more important for sensing data fusion may be associated with a higher hyper-frame quality indicator than a hyper-frame carrying data that is determined to be less important for sensing data fusion. Determining an importance to associate with data may be carried out using a pre-defined rule. In one example, importance may be identified through the use of a common semantic graph.

A sixth example rule may be defined to depend on data diversity and/or data uncertainty. That is, a hyper-frame carrying data that is determined to be more diverse and/or uncertain may be associated with a higher hyper-frame quality indicator than a hyper-frame carrying data that is determined to be less diverse and/or uncertain.

A seventh example rule may be defined to depend on a training stage. That is, a hyper-frame carrying data for later stages of training may be associated with a higher hyper-frame quality indicator than a hyper-frame carrying data for earlier stages of training. This definition follows from an understanding that an given AI/ML model may be more sensitive to error during the later stages of training.

Upon establishing a quality level for each of various hyper-frames, it is contemplated that the quality level may be used to determine a particular air interface transmission configuration to use when transmitting (step 1208, FIG. 12) a particular hyper-frame.

For air interface transmission, a separate transmission configuration may be configured for different qualities of data. Generally, a more robust transmission configuration may be used for transmitting hyper-frames carrying higher quality data, which data may include Class A sub-flows and Class B sub-flows. FIG. 17 illustrates an example air interface transmission configuration table 1700 of separate transmission configurations for transmission of hyper-frames carrying local traffic data of quality level 0 and hyper-frames carrying local traffic data of quality level 1.

According to the air interface transmission configuration table 1700 of FIG. 17, when the quality of the data carried by a given hyper-frame is level 0, available source compression ratios are 0.8 and 0.9. For UL transmission, the UE 110 may be configured to use a single bit to indicate, to the BS 170, whether to use a compression ratio of 0.8 or 0.9.

According to the air interface transmission configuration table 1700 of FIG. 17, when the quality of the data carried by a given hyper-frame is level 0, available maximum numbers of retransmission are 1 and 2. The BS 170 may determine whether use 1 or 2.

According to the air interface transmission configuration table 1700 of FIG. 17, when the quality of the data carried by a given hyper-frame is level 1, available source compression ratios are 0.4 and 0.6. It may be noted that 0.4 and 0.6 are much lower than 0.8 and 0.9. For UL transmission, the UE 110 may be configured to use a single bit to indicate, to the BS 170, whether to use a compression ratio of 0.4 or 0.6. Indeed, there may be a single bit associated with data of each class. The UE 110 may, for example, indicate, to the BS 170, that Class A data is to be compressed using a compression ratio of 0.4 and indicate, to the BS 170, that Class B data is to be compressed using a compression ratio of 0.6.

According to the air interface transmission configuration table 1700 of FIG. 17, when the quality of the data carried by a given hyper-frame is level 1, available maximum numbers of retransmission are 3 and 4. Notably, 3 and 4 are greater than 1 and 2. It may be shown that the maximum numbers of retransmission available when the quality of the data carried by a given hyper-frame is level 1 may enable more robust transmission than the transmission associated with a situation wherein the quality of the data carried by a given hyper-frame is level 0.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
receiving a packet including:
a first part, wherein the first part of the packet is represented by bits of a first class; and
a second part, wherein the second part of the packet is represented by bits of a second class;
transmitting the bits of the first class with a first air interface configuration; and
transmitting the bits of the second class with a second air interface configuration.

2. The method of claim 1, wherein each the first air interface configuration and the second air interface configuration respectively include at least one of:
source compression;
header compression;
modulation and channel coding;
retransmission;
scheduling; or
error behavior.

3. The method of claim 1, further comprising determining that the bits of the first class are more sensitive to errors than the bits of the second class.

4. The method of claim 3, wherein determining that the bits of the first class are more sensitive to errors than the bits of the second class comprises:
determining that a first target transmission block error rate associated with the bits of the first class is lower than a second target transmission block error rate associated with the bits of the second class.

5. The method of claim 3, wherein determining that the bits of the first class are more sensitive to errors than the bits of the second class comprises:
determining that the bits of the first class are associated with a first indication;
determining that the bits of the second class are associated with a second indication; and
determining, based on a comparison of the first indication with the second indication, that the bits of the first class are more sensitive to errors than the bits of the second class.

6. The method of claim 1, wherein the packet is part of a flow of local traffic representative of:
parameters describing an artificial intelligence model;
artificial intelligence training data;
sensing data; or
sensing-related parameters.

7. The method of claim 6, wherein the local traffic comprises messages generated and communicated between two radio access network (RAN) nodes only within a RAN of a wireless communication network.

8. An apparatus comprising:
at least one processor coupled with a memory storing instructions, the at least one processor caused, by executing the instructions, to perform operations comprising:
receiving a packet including:
a first part, wherein the first part of the packet is represented by bits of a first class; and
a second part, wherein the second part of the packet is represented by bits of a second class;
transmitting the bits of the first class with a first air interface configuration; and
transmitting the bits of the second class with a second air interface configuration.

9. The apparatus of claim 8, wherein each the first air interface configuration and the second air interface configuration respectively include at least one of:
source compression;
header compression;
modulation and channel coding;
retransmission;
scheduling; or
error behavior.

10. The apparatus of claim 8, wherein the operations further comprise determining that the bits of the first class are more sensitive to errors than the bits of the second class.

11. The apparatus of claim 10, wherein determining that the bits of the first class are more sensitive to errors than the bits of the second class comprises:
determining that a first target transmission block error rate associated with the bits of the first class is lower than a second target transmission block error rate associated with the bits of the second class.

12. The apparatus of claim 10, wherein determining that the bits of the first class are more sensitive to errors than the bits of the second class comprises:
determining that the bits of the first class are associated with a first indication;
determining that the bits of the second class are associated with a second indication; and
determining, based on a comparison of the first indication with the second indication, that the bits of the first class are more sensitive to errors than the bits of the second class.

13. The apparatus of claim 8, wherein the packet is part of a flow of local traffic representative of:
parameters describing an artificial intelligence model;
artificial intelligence training data;
sensing data; or
sensing-related parameters.

14. The apparatus of claim 13, wherein the local traffic comprises messages generated and communicated between two radio access network (RAN) nodes only within a RAN of a wireless communication network.

15. A non-transitory computer-readable medium comprising instructions which, when executed by at least one processor of a handheld device, cause the handheld device to perform operations comprising:
receiving a packet including:
a first part, wherein the first part of the packet is represented by bits of a first class; and
a second part, wherein the second part of the packet is represented by bits of a second class;
transmitting the bits of the first class with a first air interface configuration; and
transmitting the bits of the second class with a second air interface configuration.

16. The non-transitory computer-readable medium of claim 15, wherein each of the first air interface configuration and the second air interface configuration respectively include at least one of:
source compression;
header compression;
modulation and channel coding;
retransmission;
scheduling; or
error behavior.

17. The non-transitory computer-readable medium of claim 15, the operations further comprising determining that the bits of the first class are more sensitive to errors than the bits of the second class.

18. The non-transitory computer-readable medium of claim 17, wherein determining that the bits of the first class are more sensitive to errors than the bits of the second class comprises:
determining that a first target transmission block error rate associated with the bits of the first class is lower than a second target transmission block error rate associated with the bits of the second class.

19. The non-transitory computer-readable medium of claim 17, wherein determining that the bits of the first class are more sensitive to errors than the bits of the second class comprises:
determining that the bits of the first class are associated with a first indication;
determining that the bits of the second class are associated with a second indication; and
determining, based on a comparison of the first indication with the second indication, that the bits of the first class are more sensitive to errors than the bits of the second class.

20. The non-transitory computer-readable medium of claim 15, wherein the packet is part of a flow of local traffic representative of:
parameters describing an artificial intelligence model;
artificial intelligence training data;
sensing data; or
sensing-related parameters.
